(19) United States
(12) Patent Application Publication
(10) Pub. No.: US 2008/0076883 A1
(43) Pub. Date: Mar. 27, 2008

(54) Surface Treatment Agent

(76) Inventors: Shigeki Takeuchi, Kanagawa-ken (JP); Yuuichi Inada, Kanagawa-ken (JP)

Correspondence Address: WENDEROTH, LIND & PONACK, L.L.P., 2033 K STREET N. W., SUITE 800, WASHINGTON, DC, 20006-1021, US

(21) Appl. No.: 11/630,833

(22) PCT Filed: Jun. 24, 2005
(86) PCT No.: PCT/JP05/12151

§ 371 Date: Feb. 28, 2007

(30) Foreign Application Priority Data
Jun. 25, 2004 (JP) 2004-187533

(51) Int. Cl. C08G 77/20

(52) U.S. Cl. 525/477

(57) ABSTRACT

The present invention discloses a surface treatment agent comprising: (A) an acrylic resin having a hydrolysable silyl group, a hydroxyl group and a polysiloxane chain; (B) an organopolysiloxane having a hydrolysable silyl group; and (C) an organopolysiloxane not having a hydrolysable silyl group.

### TECHNICAL FIELD

The present invention relates to a surface treatment agent, and more particularly, to a surface treatment agent capable of concealing flaws such as scratches or polishing marks generated on surfaces to be painted of automobile bodies and the like, imparting luster and water repellency to a surface to be painted, and protecting the appearance of the surface to be painted for a long period of time.

### BACKGROUND ART

Surfaces to be painted of automobile bodies are commonly applied with wax to protect the surfaces to be painted and add luster. Although wax typically has the effect of improving luster of a surface to be painted immediately after applying, it is difficult to maintain the initial luster for a long period of time, thereby requiring the wax to be periodically applied. However, repeated application of wax has the problem of causing the formation of fine flaws in the surface to be painted.

On the other hand, paint surfaces formed on automobile bodies and so on are also frequently subjected to the occurrence of flaws and fine cracks caused by friction during washing as well as external factors such as rain, mud or sand dust in addition to the application of wax as described above, and there is a need to develop a convenient surface treatment method for concealing such flaws to make them inconspicuous.

As one example of a countermeasure against such flaws, Japanese Patent Application Laid-open No. Hei 10 (1998)-36771 discloses a specific organopolysiloxane composition used as an agent for repairing deteriorated paint films and minor flaws as well as adding luster for automotive use. This publication describes that the use of this composition is able to repair deteriorated paint films and form a highly durable paint film having superior gloss. However, since the composition described in this publication has a high content of volatile components, the volatile components tend to volatilize following application, causing a considerable decrease in the volume of the paint film over time. Consequently, when this lustering agent is applied to an indentation of a flaw formed on a surface to be painted, for example, there is the shortcoming in which the paint film contracts while drying, the majority of the indentation of the flaw ends up being exposed, flaw repair and concealment become inadequate, and the lustering effect decreases over time causing the film to be susceptible to soiling and making it difficult to wipe off adhered dirt.

In addition, Japanese Patent Application Laid-open No. 2001-172576 discloses a composition for improving water repellency or water flowability of a surface to be painted comprising a siloxane is polymer containing a hydrolysable alkoxysilyl group and a hydroxyl group, a polyisocyanate compound, and a specific amount of a reaction product of an epoxy-terminated siloxane polymer and sulfonic acid compound or a silicone oil. However, this composition has the problem of having inadequate flaw filling properties with respect to flaws in the case a surface to be painted contains deep flaws.

### DISCLOSURE OF THE INVENTION

An object of the present invention is to overcome the problems described above. Namely, an object of the present invention is to provide a surface treatment agent capable of completely concealing or repairing flaws in the case of being applied to a surface to be painted containing flaws, without the coated film shrinking in volume over time, imparting luster and water repellency to a surface to be painted that are maintained over a long period of time, and forming a film that allows adhered dirt to be removed easily.

As a result of extensive studies, the inventors of the present invention found that the above-mentioned object can be achieved by combining the three components of an acrylic resin having a hydrolysable silyl group, a hydroxyl group and a polysiloxane chain; an organopolysiloxane having a hydrolysable silyl group; and an organopolysiloxane not having a hydrolysable silyl group, thereby leading to completion of the present invention.

Thus, according to the present invention, a surface treatment agent is provided comprising:

(A) an acrylic resin having a hydrolysable silyl group, a hydroxyl group and a polysiloxane chain;

(B) an organopolysiloxane having a hydrolysable silyl group; and

(C) an organopolysiloxane not having a hydrolysable silyl group.

Since the surface treatment agent of the present invention has satisfactory applicability and demonstrates little volume shrinkage of the film following application, luster can be imparted to a surface and flaws can be easily concealed and made to be inconspicuous in a single application even in the case of applying to a surface to be painted containing flaws. In addition, a film formed by the surface treatment agent of the present invention has superior soiling resistance, weather resistance and scratch resistance, and can be applied to all types of surfaces to be painted for which the imparting of these properties is desired. Moreover, a film formed by the surface treatment agent of the present invention demonstrates luster, water repellency and water flowability over a long period of time, and allows adhered dirt to be easily removed. The application of the surface treatment agent of the present invention to a surface to be painted containing flaws in particular demonstrates remarkable effects such as being able to completely conceal and repair said flaws while also adding luster, as well as maintain an attractive appearance for a long period of time.

The following provides a more detailed explanation of the surface treatment agent of the present invention.

Acrylic Resin (A)

The acrylic resin (A) used in the present invention is a resin having a hydrolysable silyl group, a hydroxyl group and a polysiloxane chain in a molecule thereof, examples of which include that obtained by copolymerization of a siloxane macromonomer (a1), a polymerizable unsaturated monomer containing a hydrolysable silyl group (a2), a polymerizable unsaturated monomer containing a hydroxyl group (a3) and, as necessary, another polymerizable unsaturated monomer capable of being copolymerized with these components (a4).

In the present invention, a “hydrolysable silyl group” refers to a group that forms a silanol group by contacting water at room temperature, examples of which include mono-, di- and trialkoxysilyl groups, and mono-, di- and trialkanoyloxysilyl groups.

The siloxane macromonomer (a1) is a monomer component for introducing a polysiloxane chain into the acrylic resin (A) and imparting water repellency to the surface of a film formed by using the surface treatment agent of the present invention, specific examples of which include the compounds of (1) and (2) described below: 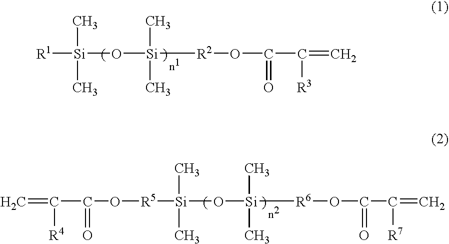
(wherein,

R¹ represents an alkyl group having 1 to 10 carbon atoms,

R² represents a divalent hydrocarbon group having 1 to 6 carbon atoms,

R³ represents a hydrogen atom or a methyl group,

R⁴ and R⁷ may be the same or different and respectively represent a hydrogen atom or a methyl group,

R⁵ and R⁶ may be the same or different and respectively represent a divalent hydrocarbon group having 1 to 6 carbon atoms, and

n¹ and n² respectively represent a number of repeating dimethyl siloxane units, a number within the range of 6 to 300, and preferably a number within the range of 6 to 100).

The siloxane macromonomer (a1) can typically have a number average molecular weight within the range of 300 to 30,000, and preferably within the range of 500 to 20,000.

In the present description, “number average molecular weight” refers to the value obtained by converting the number average molecular weight of a test polymer measured by gel permeation chromatography based on the number average molecular weight of polystyrene.

The polymerizable unsaturated monomer containing a hydrolysable silyl group (a2) is a monomer component for imparting flaw filling and dirt removability to the surface treatment agent of the present invention, examples of which include compounds having both a polymerizable double bond and a hydrolysable silyl group, such as a trialkoxysilyl or trialkanoyloxysilyl group, in a molecule thereof, with specific examples including vinyl tri(C₁-C₆ alkoxy) silanes such as vinyl trimethoxysilane, vinyl triethoxysilane or vinyl tris(2-methoxyethoxy)silane; vinyl tri(C₂-C₆ alkanoyloxy)silanes such as vinyl triacetooxysilane; and (meth)acryloyloxyalkyl tri-C₁-C₆ alkoxysilanes such as β-(meth)acryloyloxyethyl trimethoxysilane, γ-(meth)acryloyloxypropyl trimethoxysilane or γ-(meth)acryloyloxypropyl triethoxysilane.

The polymerizable unsaturated monomer containing a hydroxyl group (a3) is a monomer component for imparting a crosslinking functional group in the case the surface treatment agent of the present invention contains a crosslinking agent, and imparting suitable water flowability to the formed film, specific examples of which include C₂-C₈ hydroxyalkyl esters of (meth)acrylic acid such as 2-hydroxyethyl(meth)acrylate, 2-hydroxypropyl(meth)acrylate, 3-hydroxypropyl(meth)acrylate or hydroxybutyl(meth)acrylate; monoesters of polyether polyoles such as polyethylene glycol, polypropylene glycol or polybutylene glycol and unsaturated carboxylic acids such as (meth)acrylic acid; addition products of hydroxyalkyl vinyl ethers, allyl alcohols, hydroxyalkyl esters of (meth)acrylic acid or (poly)alkyleneglycol mono(meth)acrylates and lactones (such as ε-caprolactone or γ-valerolactone); monoethers of polyether polyoles such as polyethylene glycol, polypropylene glycol or polybutylene glycol and hydroxyl group-containing unsaturated monomers such as 2-hydroxyethyl(meth)acrylate; addition products of α,β-unsaturated carboxylic acids and monoepoxy compounds such as Caldura E10 (Shell Chemicals) or α-olefin epoxides; addition products of glycidyl(meth)acrylate and monobasic acids such as acetic acid, propionic acid, p-t-butylbenzoic acid or fatty acids; monoesterification and diesterification products of acid anhydride group-containing unsaturated compounds such as maleic anhydride or itaconic anhydride and glycols such as ethylene glycol, 1,6-hexanediol or neopentyl glycol; hydroxyalkyl vinyl ethers such as hydroxyethyl vinyl ether; hydroxyl group-containing monomers containing chloride such as 3-chloro-2-hydroxypropyl(meth)acrylate, and allyl alcohols, with C₂-C₈ hydroxyalkylesters of (meth)acrylic acid being preferable.

Examples of other polymerizable unsaturated monomers (a4) include carboxyl group-containing polymerizable unsaturated monomers such as acrylic acid, methacrylic acid, crotic acid, itaconic acid, maleic acid, fumaric acid, 2-carboxyethyl(meth)acrylate, 2-carboxypropyl(meth)acrylate and 5-carboxypentyl(meth)acrylate; C₁-C₁₈ alkyl or cycloalkyl esters of (meth)acrylic acid such as methyl (meth)acrylate, ethyl(meth)acrylate, n-propyl(meth)acrylate, i-propyl(meth)acrylate, n-butyl(meth)acrylate, i-butyl (meth)acrylate, tert-butyl(meth)acrylate, hexyl(meth)acrylate, 2-ethylhexyl(meth)acrylate, n-octyl(meth)acrylate, n-decyl (meth)acrylate, lauryl(meth)acrylate, stearyl(meth)acrylate or cyclohexyl(meth)acrylate; C₂-C₁₈ alkoxyalkyl esters of (meth)acrylic acid such as methoxybutyl(meth)acrylate, methoxyethyl (meth)acrylate or ethoxybutyl(meth)acrylate; linear alkyl vinyl ethers such as ethyl vinyl ether, n-propyl vinyl ether, isopropyl vinyl ether, butyl vinyl ether, tert-butyl vinyl ether, pentyl vinyl ether, hexyl vinyl ether or octyl vinyl ether; cycloalkyl vinyl ethers such as cyclopentyl vinyl ether or cyclohexyl vinyl ether; aryl vinyl ethers such as phenyl vinyl ether or trivinyl phenyl ether; aralkyl vinyl ethers such as benzyl vinyl ether or phenethyl vinyl ether; allyl ethers such as allyl glycidyl ether or allyl ethyl ether; vinyl esters such as vinyl acetate, vinyl propionate, vinyl lactate, vinyl butyrate, vinyl isobutyrate, vinyl caproate, vinyl isocaproate, vinyl pivalate, vinyl caprate or Beobamonomer (Shell Chemicals Limited); propenyl esters such as isopropenyl acetate or isopropenyl propionate; olefin-based compounds such as ethylene, propylene, butylenes or vinyl chloride; vinyl aromatic compounds such as styrene, α-methyl styrene, vinyl toluene or α-chlorostyrene; nitrogen-containing alkyl (meth)acrylates such as N,N-dimethylaminoethyl(meth)acrylate, N,N-diethylaminoethyl(meth)acrylate or N-t-butylaminoethyl (meth)acrylate; polymerizable amides such as acrylamide, methacrylamide, N-methyl(meth)acrylamide, N-ethyl(meth)acrylamide, N-methylol(meth)acrylamide, N-methoxymethyl(meth)acrylamide, N-butoxymethyl (meth)acrylamide, N,N-dimethyl(meth)acrylamide, N,N-dimethylaminopropyl(meth)acrylamide or N,N-dimethylaminoethyl(meth)acrylamide; aromatic nitrogen-containing monomers such as 2-vinylpyridine, 1-vinyl-2-pyrrolidone or 4-vinylpyridine; polymerizable nitriles such as acrylonitrile or methacrylonitrile; polymerizable glycidyl compounds such as glycidyl(meth)acrylate or allyl glycidyl ether; allyl monomers such as diallyl phthalate, diallyl isophthalate, triallyl isocyanurate, diallyl tetrabromophthalate, pentaerythritol diallyl ether or allyl glycidyl ether; perfluoroalkyl(meth)acrylates such as perfluorobutylethyl(meth)acrylate, perfluoroisononylethyl (meth)acrylate or perfluorooctylethyl(meth)acrylate; and polyvinyl compounds such as ethylene glycol di(meth)acrylate, diethylene glycol di(meth)acrylate, triethylene glycol di(meth)acrylate, tetraethylene glycol di(meth)acrylate, 1,3-butyelene glycol di(meth)acrylate, 1,4-butanediol diacrylate, glycerin di(meth)acrylate, glycerin tri(meth)acrylate, trimethylol propane di(meth)acrylate, trimethylol propane tri(meth)acrylate, pentaerythritol di(meth)acrylate, pentaerythritol tri(meth)acrylate, pentaerythritol tetra(meth)acrylate, dipentaerythritol penta(meth)acrylate, hydroxyisocyanurate tri(meth)acrylate, neopentyl glycol diacrylate, 1,6-hexanediol diacrylate, glycerol allyloxy(meth)acrylate, 1,1,1-tris(hydroxymethyl)ethane di(meth)acrylate, 1,1,1-tris(hydroxymethyl)ethane tri(meth)acrylate, triallyl isocyanurate, triallyl trimellitate, diallyl terephthalate, diallyl phthalate, diallyl isophthalate, pentaerythritol diallyl ether or divinylbenzene.

Although the proportions of the above-mentioned monomers (a1) to (a4) used can be suitably adjusted corresponding to the desired physical properties of the paint film, based on the total weight of monomers (a1) to (a4), the proportions used can typically be made to be such that:

the proportion of the siloxane macromonomer (a1) is within the range of 1 to 40% by weight and preferably 2 to 25% by weight;

the proportion of the polymerizable unsaturated monomer containing a hydrolysable silyl group (a2) is within the range of 5 to 50% by weight and preferably 10 to 40% by weight;

the proportion of the polymerizable unsaturated monomer containing a hydroxyl group (a3) is within the range of 1 to 40% by weight and preferably 5 to 30% by weight; and

the proportion of other polymerizable unsaturated monomers (a4) is within the range of 0 to 93% by weight and preferably 5 to 78% by weight.

Copolymerization of the monomers (a1) to (a4) can be carried out by ordinary solution polymerization, an example of which consists of reacting at a temperature of about −20° C. to about 150° C. at normal pressure, or under pressure down to about 30 kg/cm²G depending no the case, in a suitable organic solvent and in the presence of about 0.01 to about 8 parts by weight of a polymerization initiator per 100 parts by weight for the total weight of monomers (a1) to (a4).

The acrylic resin (A) having a polysiloxane chain, hydrolysable silyl group and hydroxyl group in a molecule thereof obtained in this manner can have a number average molecular weight typically within the range of 1,000 to 100,000 and preferably within the range of 3,000 to 50,000.

Organopolysiloxane Having a Hydrolysable Silyl Group (B)

The organopolysiloxane having a hydrolysable silyl group (B) used in the present invention is useful for imparting dirt removability and flaw filling to a film formed by the surface treatment agent of the present invention as a result of containing an organopolysiloxane having a hydrolysable silyl group on a terminal or side chain of the molecule, a hydrolysable silyl group such as an alkoxysilyl group in the molecule being hydrolyzed by contacting humidity in the air or moisture resulting in the formation of silanol groups, and a reaction taking place between said silanol groups or between a silanol group and another functional group within the acryl resin (A) resulting in polymerization. In general, this type of organopolysiloxane having a hydrolysable silyl group (B) preferably has a polymerized molecular weight within the range of 200 to 30,000, and particularly preferably within the range of 300 to 25,000.

Although any known compound can be used without limitation for the organopolysiloxane having a hydrolysable silyl group (B) provided it hydrolyzes and condenses at room temperature, an organopolysiloxane containing a hydrolysable silyl group having an Si—C bond (b1) is particularly preferable from the viewpoint of satisfactory dirt removability of the formed film.

This organopolysiloxane having a hydrolysable silyl group having an Si—C bond (b1) can be produced by a method such as hydrolyzing and condensing an organohalosilane having an Si—C bond in a molecule thereof and alkoxylating with alcohol, or hydrolyzing and condensing an organoalkoxysilane having an Si—C bond in a molecule thereof. More specifically, the organopolysiloxane having a hydrolysable silyl group having an Si—C bond (b1) can be produced by using as a raw material at least one type of organosilane compound selected from the organosilane compounds having an Si—C bond represented by the following formulas (3) to (5), and hydrolyzing and condensing those raw materials.
R⁸SiX₃ (3)
R⁸₂SiX₂ (4)
R⁸₃SiX (5)
SiX₄ (6)

In formulas (3) to (5) above, R⁸ may be the same or different and respectively represents an optionally substituted hydrocarbon group or polymerizable unsaturated group, and X may be the same or different and represents a hydroxyl group, alkoxy group, aryloxy group or halogen atom.

Specific examples of R⁸ include C₁-C₂₀ alkyl groups such as a methyl, ethyl, n-propyl, i-propyl, n-butyl, i-butyl, tert-butyl, n-pentyl, i-pentyl, n-hexyl, i-hexyl, n-heptyl, i-heptyl, n-octyl, i-octyl, n-nonyl, n-decyl or n-octadecyl group; C₃-C₈ cycloalkyl groups such as a cyclopentyl or cyclohexyl group; aryl groups such as a phenyl, tolyl, xylyl or napthyl group; aralkyl groups such as a benzyl, phenethyl or phenylpropyl group; halogenated alkyl groups such as a 3-chloropropyl or 3,3,3-trifluoropropyl group; alkenyl groups such as a vinyl, allyl, i-propenyl, 1-butenyl, 2-butenyl or 3-butenyl group; cycloalkenyl groups such as a 2-cyclohexenyl or 3-cyclohexenyl group; vinylcycloalkyl groups such as a 2-vinylcyclohexyl, 3-vinylcyclohexyl or 4-vinylcyclohexyl group; alkenylaryl groups such as a 2-vinylphenyl, 3-vinylphenyl, 4-vinylphenyl, 2-allylphenyl, 3-allylphenyl or 4-allylphenyl group; polymerizable unsaturated groups such as a 3-allyloxypropyl or 3-(meth)acryloyloxypropyl group; aminoalkyl groups such as an aminoethyl or 3-aminopropyl group; and glycidoxyalkyl groups such as a 3-glycidoxypropyl group.

On the other hand, examples of X include C₁-C₂₀ alkoxy groups such as a methoxy, ethoxy, n-propoxy, i-propoxy, n-butoxy, i-butoxy, tert-butoxy, n-pentyloxy, i-pentyloxy, n-hexyloxy or i-hexyloxy group; aryloxy groups such as a phenoxy group; and halogens such as chlorine, bromine or fluorine.

Specific examples of the organosilane compounds represented by the above-mentioned formulas (3) to (5) include monoalkoxysilanes such as trimethylmethoxysilane; dialkoxysilanes such as dimethyldimethoxysilane or diphenyldimethoxysilane; trialkoxysilanes such as methyltrimethoxysilane, methyltriethoxysilane or phenyltrimethoxysilane; and organohalosilanes such as dimethyldichlorosilane or trimethylchlorosilane.

In addition, specific examples of the organosilane represented by the above-mentioned formula (6) include tetraalkoxysilanes such as tetramethoxysilane, tetraethoxysilane, tetrapropoxysilane or tetraphenoxysilane; and tetrahalosilanes such as tetrachlorosilane.

The organopolysiloxane having a hydrolysable silyl group having an Si—C bond (b1) is preferably an organopolysiloxane having a three-dimensional structure typically produced using an organosilane compound represented by formula (3) and/or formula (4) as the main component of the raw material. In addition, an organosilane compound represented by formula (5) and/or formula (6) can be suitably used in combination as a portion of the raw materials for the purpose of adjusting the hardness, plasticity, bending resistance and so on of the paint film.

In addition, the organopolysiloxane containing a hydrolysable silyl group (B) may also be a substantially linear organopolysiloxane produced using a bifunctional organosilane compound represented by formula (4) as the main component of the raw materials.

Moreover, the organopolysiloxane having a hydrolysable silyl group (B) may also be an organopolysiloxane not having a linear, branched or cyclic Si—C bond produced using the tetrafunctional organosilane compound represented by formula (6) as the main component of the raw materials.

In order to reduce the ease of soiling of a film formed by using the surface treatment agent of the present invention or allow the film to demonstrate dirt removability, the organopolysiloxane having a hydrolysable silyl group (B) preferably has a methyl group as a substituent bound to a silicon atom, and the concentration of that methyl group is typically 20 mol % or more and preferably 40 mol % or more.

The “methyl group concentration” of the organopolysiloxane (B) in the present description can be calculated based on the following equation:
Methyl group concentration of organopolysiloxane(B)(mol %)=(n4/n3)×100

(wherein, n3 represents the total number of moles of substituent R⁸ in the organopolysiloxane (B), and n4 represents the number of moles of the methyl group in substituent R⁸).

In addition, from the viewpoint of superior spreadability and flaw filling of the prepared surface treatment and removability of adhered dirt, the organopolysiloxane having a hydrolysable silyl group (B) preferably contains an organopolysiloxane (b2) having both an organopolysiloxane backbone having a three-dimensional structure and a linear organopolysiloxane backbone in a molecule thereof.

An example of a linear organopolysiloxane backbone is the structure shown in the following formula (7).

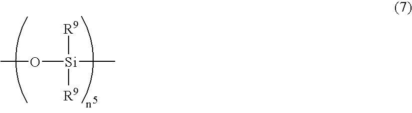

In formula (7), n⁵ represents an integer of 2 to 1,000, and R⁹ may be the same or different and respectively represents an optionally substituted hydrocarbon group. Said hydrocarbon group may be saturated or unsaturated, examples of which include a C₁-C₂₀ alkyl group such as a methyl, ethyl, n-propyl, i-propyl, n-butyl, i-butyl, tert-butyl, n-pentyl, i-pentyl, n-hexyl, i-hexyl, n-heptyl, i-heptyl, n-octyl, i-octyl, n-nonyl, n-decyl or n-octadecyl group; a C₃-C₈ cycloalkyl group such as a cyclopentyl or cyclohexyl group; an allyl group such as a phenyl, tolyl, xylyl or naphthyl group; an aralkyl group such as a benzyl, phenethyl or phenylpropyl group; a halogenated alkyl group such as a 3-chloropropyl or 3,3,3-trifluoropropyl group; an aminoalkyl group such as an aminoethyl or 3-aminopropyl group; and a glycidoxyalkyl group such as a 3-glycidoxypropyl group, with a methyl group being particularly preferable from the viewpoint of the dirt removability of the film formed using the surface treatment agent.

The organopolysiloxane (b2) having both an organopolysiloxane backbone having a three-dimensional structure and a linear organopolysiloxane backbone in a molecule thereof can be produced by, for example, (1) a method in which an organopolysiloxane having a three-dimensional structure containing an alkoxy group and a polymerizable unsaturated group in a molecule thereof is reacted with a linear organopolysiloxane containing Si—H groups on both terminals; or (2) a method in which an organopolysiloxane having a three-dimensional structure containing an alkoxy group and an Si—H group in a molecule thereof is reacted with a linear organopolysiloxane containing a polymerizable unsaturated group on both terminals.

Examples of the above-mentioned polymerizable unsaturated group include a C₂-C₁₀ alkenyl group such as a vinyl, allyl, i-propenyl, 1-butenyl, 2-butenyl or 3-butenyl group; a C₃-C₈ cycloalkenyl group such as a 2-cyclohexenyl or 3-cyclohexenyl group; a vinylcyclohexyl group such as a 2-vinylcyclohexyl, 3-vinylcyclohexyl or 4-vinylcyclohexyl group; a vinylphenyl group such as a 2-vinylphenyl, 3-vinylphenyl or 4-vinylphenyl group; an allylphenyl group such as a 2-allylphenyl, 3-allylphenyl or 4-allylphenyl group; and a 3-allyloxypropyl group or 3-(meth)acryloyloxypropyl group, with a vinyl group being preferable due to its reactivity with Si—H groups.

The methods of (1) and (2) can be carried out in accordance with ordinary methods by a hydrosilylation reaction using a metal such as Ni, Rh, Pd or Pt or compound or complex thereof as a catalyst in the presence of an organic solvent such as hexane, pentane, toluene or xylene as necessary.

In the methods of (1) and (2), in order to minimize the amount of unreacted linear organopolysiloxane and obtain the target compound without causing gelling, the functional group of the organopolysiloxane having a three-dimensional structure (polymerizable unsaturated group or Si—H group) is preferably in excess with respect to the functional group of the linear organopolysiloxane (Si—H group or polymerizable unsaturated group).

The organopolysiloxane having a hydrolysable silyl group (B) preferably contains the above-mentioned organopolysiloxane (b2) normally within the range of 20% by weight or less and preferably within the range of 5 to 15% by weight based on the amount of the organopolysiloxane (B) in terms of dirt removability and curability (drying to the touch).

In the present invention, the organopolysiloxane having a hydrolysable silyl group (B) can also be acquired commercially, and examples of commercially available products include SR2406, SR2410, SR2420, SR2416, SR2402 and AY42-161 (trade names, all available from Toray Dow-Corning Silicone Co., Ltd.), FZ-3704 and FZ-3511 (trade names, available from Nippon Unicar Company Limited), and KC-89S, KR-500, X-40-9225, X-40-9246, X-40-9250, KR-217, KR-9218, KR-213, KR-510, X-40-9227, X-40-9247, X-41-1053, X-41-1056, X-41-1805, X-41-1810, X-40-2651, X-40-2308, X-40-9238, X-40-2239, X-40-2327, KR-400, X-40-175 and X-40-9740 (trade names, all available from Shin-Etsu Chemical Co., Ltd.). These can each be used alone or as a combination of two or more types.

Organopolysiloxane not Having a Hydrolysable Silyl Group (C)

The organopolysiloxane not having a hydrolysable silyl group (C) used in the present invention preferably is that which is not substantially hydrolyzed or condensed, is incorporated into the surface treatment agent of the present invention for the purpose of improving spreadability and other aspects of coating work and wiping work (leveling), and imparting water flowability to the formed film, and has viscosity of 10,000 cSt (25° C.) or less, preferably within the range of 0.5 to 5,000 cSt (25° C.), and more preferably within the range of 1 to 3,000 cSt (25° C.). Said viscosity can be measured with a Ostwald viscometer.

Examples of the organopolysiloxane not having a hydrolysable silyl group (C) include silicone oils in the manner of polysiloxane-type silicone oils such as dimethyl polysiloxane or phenylmethyl polysiloxane; polyether-modified silicone oils having a polyoxyalkylene group in a side chain thereof such as a polyether-modified dimethyl polysiloxane-type silicone oil or alkyl-polyether-modified dimethyl polysiloxane-type silicone oil; alcohol-modified dimethyl polysiloxane-type silicone oils; and hydroxyl group-containing dimethyl polysiloxane-type silicone oils, and these can each be used alone or in a combination of two or more types. Polyether-modified silicone oils having a polyoxyalkylene group are particularly preferable from the viewpoints of spreadability and leveling.

In addition, a linear or cyclic low molecular weight organopolysiloxane having a molecular weight within the range of 200 to 1,000 and preferably within the range of 300 to 700 can be used for the organopolysiloxane not having a hydrolysable silyl group (C).

Specific examples of such low molecular weight organopolysiloxanes include linear polysiloxanes such as heptamethyloctyl trisiloxane; and cyclic polysiloxanes such as decamethylcyclopentasiloxane, octamethylcyclotetrasiloxane or dodecamethylcyclohexasiloxane, and these can each be used alone or as a combination of two or more types.

Surface Treatment Agent

The surface treatment agent of the present invention can be prepared by mixing the above-mentioned acrylic resin (A), the organopolysiloxane having a hydrolysable silyl group (B), and the organopolysiloxane not having a hydrolysable silyl group (C). Although the mixing ratio thereof can be varied over a wide range corresponding to the application and so on of the surface treatment agent, in general, the ratio of the acrylic resin (A) is within the range of 10 to 70% by weight, preferably 20 to 40% by weight and more preferably 20 to 35% by weight, the ratio of the organopolysiloxane having a hydrolysable silyl group (B) is within the range of 25 to 85% by weight, preferably 25 to 70% by weight, and more preferably 30 to 60% by weight, and the ratio of the organopolysiloxane not having a hydrolysable silyl group (C) is within the range of 5 to 65% by weight, preferably 5 to 40% by weight, and more preferably 10 to 35% by weight, based on the total weight of the acrylic resin (A), the organopolysiloxane having a hydrolysable silyl group (B) and the organopolysiloxane not having a hydrolysable silyl group (C).

If the blended amount of the acrylic resin (A) is less than 10% by weight, the curability of the surface treatment agent of the present invention becomes inadequate, while if the blended amount exceeds 70% by weight, a homogeneous film cannot be obtained. If the blended amount of the organopolysiloxane having a hydrolysable silyl group (B) is less than 25% by weight, a homogeneous film is not obtained and dirt removability becomes inadequate, while conversely, if the blended amount exceeds 85% by weight, the interior of the film may not be cured in the case of a thick film, thereby making it difficult to form a film. If the blended amount of the organopolysiloxane not having a hydrolysable silyl group (C) is less is than 5% by weight, the water flowability of a film formed from the surface treatment agent of the present invention becomes inadequate, and wettability to a surface to be painted decreases. On the other hand, if the blended amount exceeds 65% by weight, the film formed from the surface treatment agent of the present invention softens, and functions such as dirt removability and flaw filling decrease.

In the surface treatment agent of the present invention, a curing catalyst can be incorporated depending on the case to promote hydrolysis and condensation of the hydrolysable silyl groups respectively contained in the acrylic resin (A) and the organopolysiloxane having a hydrolysable silyl group (B). Examples of said curing catalyst include organic tin compounds such as diacetyl tin diacetate, dibutyl tin dilaurate, dibutyl tin diacetate, dioctyl tin dilaurate, diacetyl tin dioctoate, tin octoate, dibutyl tin diacetate or dibutyl tin dioctoate; organic aluminum compounds such as aluminum trimethoxide, aluminum tris(acetylacetonate), aluminum tri-n-butoxide, aluminum tris(ethylacetoacetate), aluminum diisopropoxy(ethylacetoacetate) or aluminum acetylacetonate; organic titanium compounds such as titanium tetra(monomethylethoxide), titanium tetra(monoethylethoxide), titanium tetra(monobutylethoxide), titanium tetraquis(acetylacetonate) or tetra-n-butyl titanate; organic zirconium compounds such as zirconium tetra(monomethylethoxide), zirconium tetra(monoethylethoxide), zirconium tetra(monobutylethoxide), zirconium n-propylate, zirconium n-butyrate or zirconium tetraquis(acetyl acetonate); organic zinc compounds such as zinc naphthenate; organic cobalt compounds such as cobalt octoate or cobalt naphthenate; and boric acid compounds such as boric acid esters such as trimethyl borate, triethyl borate, tripropyl borate, tributyl borate, triphenyl borate, tri(4-chlorophenyl) borate or trihexafluoroisopropyl borate. These compounds can be respectively used alone or two or more types can be used in combination. Said curing catalyst is contained within the range of 0.1 to 10% by weight, and preferably 0.2 to 7% by weight, based on the total weight of components (A) and (B).

The surface treatment agent of the present invention can also contain a polyisocyanate compound (D) as necessary. The polyisocyanate compound (D) is used as a curing agent, imparts improved drying of the surface treatment agent of the present invention by reacting with hydroxyl groups contained in the acrylic resin (A), and is useful for introducing a crosslinked structure into the formed film. Examples of said polyisocyanate compound (D) include aliphatic diisocyanates such as lysine diisocyanate, hexamethylene diisocyanate or trimethylhexane diisocyanate; cyclic aliphatic diisocyanates such as hydrogenated xylylene diisocyanate, isophorone diisocyanate, methylcyclohexane-2,4 (or 2,6)-diisocyanate, 4,4′-methylenebis(cyclohexylisocyanate) or 1,3-(isocyanatomethyl)cyclohexane; aromatic diisocyanates such as tolylene diisocyanate, xylylene diisocyanate or diphenylmethane diisocyanate; organic polyisocyanates in the manner of polyisocyanates having a valence of 3 or more such as lysine triisocyanate or addition products of these organic polyisocyanates and polyalcohols, low molecular weight polyester resins or water, cyclic polymers of organic diisocyanates as described above (such as isocyanurates), and biuret addition products. Among these, isocyanurates of hexamethylene diisocyanate are particularly preferable. These can each be used alone or two or more types can be used in combination.

The amount of the above-mentioned polyisocyanate compound (D) used is suitably selected so that the isocyanate groups contained in the polyisocyanate compound (D) is typically within the range of 0.3 to 3.0 equivalents and preferably 0.5 to 2.5 equivalents based on one equivalent of active hydrogen groups contained in the acrylic resin (A).

In addition, a particle flow adjuster in the manner of polytetrafluoroethylene or colloidal silica can be blended into the surface treatment agent of the present invention as necessary from the viewpoint of improving flaw filling.

An example of the polytetrafluoroethylene is a particulate material having an average particle diameter of 10 μm or less. Flaw filling of a film surface when using the surface treatment agent of the present invention can be improved by blending in this form of polytetrafluoroethylene. Although said particulate polytetrafluoroethylene may be blended in the form of a dry powder, it may also be in the form of a dispersion by preliminarily mixing with a dispersion medium, dispersion and/or dispersing resin. The blended amount of said polytetrafluoroethylene is within the range of 1 to 100 parts by weight, and preferably 1 to 50% by weight, based on the total weight of components (A), (B) and (C).

On the other hand, colloidal silica is a dispersion in which ultra-fine particles of silicic anhydride are dispersed in a solvent. The silica particles can have an average particle diameter of about 5 to 200 nm, and examples of solvents used include alcohols such as methanol, ethanol, propanol or ethylene glycol; ketones such as acetone, methyl ethyl ketone or methyl isobutyl ketone; esters such as ethyl acetate or butyl acetate; ethers such as diisopropyl ether; and mixtures thereof. Commercially available products can be used for the colloidal silica, examples of which include members of the “Snowtex” series (trade name, Nissan Chemical Industries, Ltd.), and Oscal (trade name, Catalysts & Chemicals Ind. Co., Ltd.). The blended amount of the colloidal silica is within the range of 1 to 100% by weight and preferably 1 to 50% by weight based on the total weight of components (A), (B) and (C).

Furthermore, the average particle diameter of the particulate component in the present description is the value of the 50% average particle diameter as determined by laser diffraction.

The surface treatment agent of the present invention preferably contains a dehydrating agent in consideration of storage stability. A known dehydrating agent can be used for said dehydrating agent, specific examples of which include metal alkoxides such as aluminum isopropylate, aluminum sec-butyrate, tetraisopropyl titanate, tetra-n-butyl titanate, zirconium n-butyrate, ethyl silicate or vinyl trimethoxysilane; organic alkoxy compounds such as methyl orthoformate, ethyl orthoformate, methyl orthoacetate, ethyl orthoacetate, isopropyl orthoacetate or dimethoxypropane; and monofunctional isocyanates such as “Additive TI” (trade name, Sumika Bayer Urethane Co., Ltd.). These can be used alone or two or more types can be used in combination. The blended amount of said dehydrating agent can typically be within the range of 0.1 to 10% by weight and preferably 0.2 to 7% by weight based on the total weight of components (A), (B) and (C).

In addition, the surface treatment agent of the present invention can contain an organic solvent as necessary for the purpose of improving coating workability and adjusting curing rate. Examples of this organic solvent include aliphatic-based organic solvents such as n-hexane, n-octane, i-octane, n-nonane, cyclohexane, methylcyclohexane or mineral spirits; petroleum-based organic solvents such as Swasol 100 (trade name, Maruzen Petrochemical Co., Ltd.), petroleum ether, petroleum benzene or petroleum naphtha; aromatic-based solvents such as toluene or xylene; ketone-based organic solvents such as methyl ethyl ketone or methyl isobutyl ketone; and ester-based organic solvents such as butyl acetate. These can each be used alone or two or more types can be used in combination. Said organic solvent can typically be used within the range of 50 to 700% by weight and preferably 100 to 600% by weight based on the total weight of components (A), (B) and (C).

In addition, an ultraviolet absorber and/or photostabilizer is preferably blended into the surface treatment agent for the purpose of improving the weather resistance of the formed film. A known ultraviolet absorber can be used for the ultraviolet absorber, specific examples of which include benzotriazole-based, triazine-based, anilide-based, benzophenone-based, anilide oxalate-based and cyanoacrylate-based ultraviolet absorbers, while examples of commercially available products that can be used include Tinuvin 1130 and Tinuvin 400 (trade names, Ciba Specialty Chemicals K. K.), Cyasorb UV-1164L (trade name, Mitsui Cytec Ltd.), and Sanduvor 3206 (trade name, Clariant (Japan) K. K.). Said ultraviolet absorber is used within the range of 0.5 to 10% by weight and preferably 1 to 7% by weight based on the total weight of components (A), (B) and (C).

In addition, examples of photostabilizers include (bis(2,2,6,6-tetramethyl-4-piperidyl)sebacate, bis(1,2,2,6,6-pentamethyl-4-piperidyl)sebacate, bis(1-methoxy-2,2,6,6-tetramethyl-4-piperidyl)sebacate, bis(1-ethoxy-2,2,6,6-tetramethyl-4-piperidyl)sebacate, bis(1-propoxy-2,2,6,6-tetramethyl-4-piperidyl)sebacate, bis(1-butoxy-2,2,6,6-tetramethyl-4-piperidyl)sebacate, bis(1-pentyloxy-2,2,6,6-tetramethyl-4-piperidyl)sebacate, bis(1-hexyloxy-2,2,6,6-tetramethyl-4-piperidyl)sebacate, bis(1-heptyloxy-2,2,6,6-tetramethyl-4-piperidy-piperidyl)sebacate, bis(1-octoxy-2,2,6,6-tetramethyl-4-piperidyl)sebacate, bis(1-nonyloxy-2,2,6,6-tetramethyl-4-piperidyl)sebacate, bis(1-decanyloxy-2,2,6,6-tetramethyl-4-piperidyl)sebacate, and bis-(1-dodecyloxy-2,2,6,6-tetramethyl-4-piperidyl)sebacate, while examples of commercially available products include Sanol LS-292 (trade name, Mitsui Lifetech Co., Ltd.) and Tinuvin 292 or Tinuvin 123 (trade names, Ciba Specialty Chemicals K. K.). Said photostabilizer is used within the range of 0.3 to 10% by weight and preferably 0.5 to 7% by weight based on the total weight of components (A), (B) and (C).

A colorant such as a coloring pigment, glossy pigment or dye can be contained in the surface treatment agent of the present invention as necessary for the purpose of giving the surface treatment agent the same color as the surface to be painted.

The surface treatment agent of the present invention can also suitably incorporate a modifying resin such as a urethane resin, epoxy resin, amino resin, polyester resin, acryl silicon resin or fluororesin; a titanium oxide having photocatalytic activity; a needle-shaped single crystal inorganic powder such as zinc whisker; a saline coupling agent; a titanium coupling agent; an additive such as a surface adjuster, viscosity adjuster, surfactant, film formation assistant or thickener; or a crosslinking agent such as melamine resin as necessary.

The surface treatment agent of the present invention composed of the above-mentioned components allows the obtaining of a formed film having water repellency and water flowability, the water contact angle of the formed film is 85° or more, and the water sliding angle is 40° or more. In the present description, the water sliding angle refers to the minimum angle of inclination relative to the horizontal direction of the formed film at which water droplets on the formed film are able to slide under their own weight. The water contact angle and water sliding angle of the formed film can be adjusted experimentally by adjusting the content of the hydrolysable silyl group in the surface treatment agent and the blended amount of the organopolysiloxane not containing a hydrolysable silyl group (C).

In addition, the surface treatment agent of the present invention may be suitably provided in the form of a single liquid or two-liquid paint according to the composition thereof, and in the case of a two-liquid paint, is normally used for painting after mixing immediately prior to use.

The following provides an explanation of a method for applying the surface treatment agent to a surface to be painted.

The coating method may be a known method, examples of which include a smearing method by which the surface treatment agent is smeared with a smearing material such as a sponge or cloth, spray coating, brush coating, dip coating or roll coating, followed by wiping off any excess surface treatment agent as necessary with a wiping material.

There are no particular limitations on the substance used for the smearing material provided it does not damage the surface to be painted and is not penetrated by the surface treatment agent, examples of which include polyester, polypropylene, acryl, cotton, silk, hemp, wool, polyurethane or Nylon. Examples of forms of the smearing material include a sponge, cloth, flannel, felt and fleece. In addition, the material used for the wiping material can be suitably selected from those having a material and shape similar to the materials listed in the explanation of the smearing material.

Application of the surface treatment agent of the present invention can be carried out by spreading with a cloth or by a method ordinarily used to apply waxes and coating agents such as by spreading with a cloth after having coated in the form of a mist by spraying. The coated film is normally dried at room temperature or can be forcibly dried at a temperature of about 100° C. or lower.

There are no particular limitations on the surface to be painted to which the surface treatment agent of the present invention can be applied, and various types of base material surfaces and painted surfaces of various types of base materials to which paint has been applied can be used. Examples of base materials include metals such as iron, zinc or iron/zinc alloys; inorganic base materials such as wood, concrete, mortar board, slate, siding materials, ceramic tile wall surfaces, autoclaved lightweight concrete, mortar, brick, stone or glass; plastic materials; leather; and fibers.

On the other hand, there are no particular limitations on the painted surface of the base material to which paint has been applied, examples of which include top coating paint films formed by applying a solid color paint, top coating paint films formed by applying a metallic paint, top coating paint films formed by applying an optically non-interfering paint, top coating paint films formed by applying a clear paint, and multilayer paint films formed by sequentially applying two or more types of top coating paints selected from solid color paint, metallic paint and clear paint. In addition, the top coating paint preferably forms a cured paint film, and a bottom coating and/or intermediate coating paint film may also be present beneath these top coating paint films.

The painted surface of the base material to which paint has been applied may be a newly provided painted surface or an existing painted surface. In the case of a newly provided painted surface, the formation of flaws or decrease in luster can be inhibited by applying the surface treatment agent of the present invention. On the other hand, in the case of an existing painted surface, and particularly a painted surface containing flaws, application of the surface treatment agent of the present invention is able to impart luster to the painted surface while also completely filling in (repairing) flaws having a depth of about 5 μm or less, and particularly flaws having a depth of about 3 μm or less. In the case the surface to be painted is a painted surface on which a clear paint film has been formed (including multilayer paint films in which a clear paint film has been formed on the uppermost layer) in particular, application of the surface treatment agent of the present invention is capable of making flaws formed in said clear painted surface inconspicuous, thereby prominently demonstrating the effects thereof. Specific examples of such surfaces to be painted include those of passenger cars, trucks, buses, motorcycles, trains and other vehicles, aircraft, buildings and home appliances.

In addition, although application of the surface treatment agent of the present invention makes it possible to revitalize the luster and other aspects of appearance of an existing painted surface of a base material as well as maintain that appearance for a long period of time, a wax or lustering agent, such as a known hydrophobic wax containing a hydroxyl group-containing siloxane polymer and polyisocyanate compound, may be additionally applied to the film formed by said surface treatment agent as necessary.

### EXAMPLES

Although the following provides a more detailed explanation of the present invention through examples thereof, the scope of the present invention is not limited to only these examples. Furthermore, the terms “parts” and “%” refer to “parts by weight” and “% by weight”, respectively.

Production of an Acrylic Resin Solution having a Hydrolysable Silyl Group, Hydroxyl Group and Polysiloxane Chain (A)

### Production Example 1

81.8 parts of n-butyl acetate were charged into a four-mouth flask equipped with a thermometer, reflux condenser, stirrer and dropping device followed by heating while stirring and holding at a temperature of 95° C. Next, a mixture comprised of 20 parts of Silaplane FM-0721 (see Note 1), 30 parts of γ-methacryloyloxypropyl trimethoxysilane, 10 parts of 2-hydroxyethyl methacrylate, 40 parts of i-butyl methacrylate and 4.2 parts of a photopolymerization initiator in the form of 2,2′-azobis(2,4-dimethylvaleronitrile) was dropped in over the course of 3 hours at a temperature of 95° C. Following completion of dropping, the mixture was aged for 2 hours at a temperature of 95° C. to obtain a solution of a siloxane polymer having a solid content concentration of 55%, number average molecular weight of 10,000 and containing hydrolysable alkoxysilyl groups and hydroxyl groups (A1). Furthermore, the molecular weight was measured using the HLC8120 GPC system available from Tosoh, a differential refractometer for the detector, the G4000XL, G3000XL, G2500XL and G2000XL columns available from Tosoh Corporation for the columns, tetrahydrofuran for the mobile phase and under conditions of a measuring temperature of 40° C. and flow rate of 1 cc/min.
Note 1: Silaplane FM-0721: trade name, Chisso Corporation, methacrylic group-containing siloxane macromonomer, number average molecular weight: 5,000, structural formula shown below (wherein, R represents an alkyl group having 1 to 8 carbon atoms, and m is about 70).

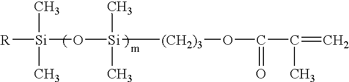

Production of Organopolysiloxane Having a Hydrolysable Silyl Group (B)

### Production Example 2

80 parts of methyl trimethoxysilane and 20 parts of dimethyl dimethoxysilane were added to a three-mouth flask followed by dropping in 10 parts of 0.05 N aqueous hydrochloric acid while stirring and hydrolyzing and condensing for 1 hour at 68° C. This was then heated to 120° C. to remove the by-product methanol followed by filtering to obtain an organopolysiloxane having a hydrolysable silyl group (B1).

### Production Example 3

85 parts of methyl trimethoxysilane and 15 parts of vinylmethyl dimethoxysilane were added to a three-mouth flask followed by dropping in 10 parts of 0.05 N aqueous hydrochloric acid while stirring and hydrolyzing and condensing for 2 hours at 68° C. This was then heated to 120° C. to remove the by-product methanol followed by filtering to obtain an organopolysiloxane having an alkoxy group (b1).

250 parts of the organopolysiloxane (b1), 125 parts of a component having a linear dimethyl polysiloxane backbone in the form of a dimethyl polysiloxane having an Si—H group on both ends thereof (see Note 2) and 1.5 parts of CAT-PL-50T (trade name, Shin-Etsu Chemical, Pt-based catalyst) were added to a different three-mouth flask followed by hydrosilylation for 8 hours at 80° C. This was then treated under reduced pressure at 120° C. and 10 mmHg for 2 hours followed by filtering to obtain an organopolysiloxane having an organopolysiloxane having a three-dimensional structure and a linear dimethyl polysiloxane backbone in a molecular thereof, and having a hydrolysable silyl group (B2).
Note 2: Dimethyl polysiloxane oil: Composed mainly of H-[Me₂SiO]₁₉-Me₂Si—H.

Preparation of Surface Treatment Agents

### Examples 1-8 and Comparative Examples 1-3

Each component shown in Table 1 was blended according to the compositions shown in Table 1 followed by stirring and mixing to obtain each of the treatment agents. Furthermore, Notes 3 to 6 in Table 1 are as indicated below.
Note 3: KF-618: Shin-Etsu Silicones, polyether-modified dimethyl polysiloxane-based silicone oil, viscosity: 20 cSt (25° C.)
Note 4: Snowtex MIBK-ST: Nissan Chemical Industries, Ltd., organic solvent-based colloidal silica, non-volatile component content: 30%
Note 5: Fluon PTFE Lubricant L173J: Asahi Glass Co., Ltd., polytetrafluoroethylene powder, average particle diameter: 7 μm

Note 6: Duranate TPA-90EK: Asahi Kasei Corporation, isocyanurate form of hexamethylene diisocyanate, non-volatile component content: 90%, isocyanate group content: 21%

TABLE 1

| | Examples | | | | | | | | Comparative Examples | | |
|---|---|---|---|---|---|---|---|---|---|---|---|
| Surface Treatment Agent | 1 | 2 | 3 | 4 | 5 | 6 | 7 | 8 | 1 | 2 | 3 |

Base

| | | | | | | | | | | | |
|---|---|---|---|---|---|---|---|---|---|---|---|
| Acrylic resin solution (A1) | 181.8 | 181.8 | 181.8 | 181.8 | 181.8 | 181.8 | 181.8 | 181.8 | 181.8 | 0 | 181.8 |
| Organopolysiloxane (B1) | 95 | 165 | 150 | 125 | 130 | 140 | 150 | 100 | 125 | 100 | 0 |
| Organopolysiloxane (B2) | | 15 | 10 | 15 | | | 15 | | | | |
| KF-618 (Note 3) | 104 | 33 | 135 | 125 | 57 | 50 | 35 | 100 | 0 | 100 | 100 |
| Snowtex MIBK-ST (Note 4) | | | | | 20 | | | | | | |
| Fluon PTFE Lubricant | | | | | | 10 | | | | | |
| L173J (Note 5) | | | | | | | | | | | |
| Anilide oxalate | 8 | 8 | 8 | 4 | 8 | 8 | 6 | 6 | 6 | 6 | 6 |
| Bis(1,2,2,6,6- | 3 | 3 | 3 | 4 | 3 | 3 | 4 | 4 | 4 | 3 | 3 |
| pentamethyl-4- | | | | | | | | | | | |
| piperidyl)sebacate | | | | | | | | | | | |
| Dibutyl tin dilaurate | 1 | 1 | 1 | 3.3 | 0.5 | 0.5 | 4 | 2 | 2 | 3 | 3 |
| n-butyl acetate | 300 | 300 | 300 | 300 | 300 | 300 | 550 | 350 | 250 | 250 | 250 |

Curing Agent

| | | | | | | | | | | | |
|---|---|---|---|---|---|---|---|---|---|---|---|
| Duranate TPA-90EK | 18.1 | 18.1 | 18.1 | | 18.1 | 18.1 | 18.1 | 18.1 | 18.1 | 0 | 18.1 |
| (Note 6) | | | | | | | | | | | |
| Active hydrogens/ | 1.0 | 1.0 | 1.0 | 0.0 | 1.0 | 1.0 | 1.0 | 1.0 | 1.0 | 0 | 1.0 |
| isocyanate groups | | | | | | | | | | | |

Application to Automobile Body

### Examples 9-16 and Comparative Examples 5-8

After using a cloth to rub on each of the surface treatment agents of Examples 1 to 8 and Comparative Examples 1 to 3 along with the surface treatment agent of Comparative Example 4 in the form of carnauba wax onto an automobile exterior panel on which was formed a multilayer paint film having a clear paint for the uppermost layer containing fine flaws (depth of about 1 μm) caused by washing and waxing, the wax was uniformly wiped off with a different clean cloth followed by testing of each of the resulting samples.

Performance Evaluation

The following evaluations were performed on each of the resulting test samples. Those results are shown in Table 2.

TABLE 2

| | | | | | | | | | Comparative Examples | | | |
|---|---|---|---|---|---|---|---|---|---|---|---|---|
| | Examples | | | | | | | | 5 | 6 | 7 | 8 |
| Type of Surface | 9 | 10 | 11 | 12 | 13 | 14 | 15 | 16 | Comp. | Comp. | Comp. | Comp. |
| Treatment Agent | Ex. 1 | Ex. 2 | Ex. 3 | Ex. 4 | Ex. 5 | Ex. 6 | Ex. 7 | Ex. 8 | Ex. 1 | Ex. 2 | Ex. 3 | Ex. 4 |
| Flaw concealment | ◯ | ◯ | ◯ | ◯ | ◯ | ◯ | ⊙ | ◯ | Δ | ◯ | X | Δ |
| (*1) | | | | | | | | | | | | |
| Painting | ◯ | ◯ | ◯ | ◯ | ◯ | ◯ | ◯ | ◯ | Δ | ◯ | Δ | Δ |
| workability | | | | | | | | | | | | |
| (*2) | | | | | | | | | | | | |
| Dirt removability | ⊙ | ⊙ | ◯ | ◯ | ⊙ | ⊙ | ⊙ | ◯ | Δ | X | Δ | X |
| (*3) | | | | | | | | | | | | |
| Water contact angle | ◯ | ◯ | ◯ | ◯ | ◯ | ◯ | ◯ | ◯ | ◯ | X | Δ | Δ |
| (*4) | | | | | | | | | | | | |
| Water sliding angle | ◯ | ◯ | ◯ | ◯ | ◯ | ◯ | ◯ | ◯ | X | X | Δ | X |
| (*5) | | | | | | | | | | | | |

(*1) Flaw Concealment
Each of the test samples coated with the surface treatment agents was visually observed outdoors under sunlight, and whether or not the flaws prior to application of the surface treatment agent were concealed was evaluated based on the criteria indicated below.
⊙: No visible flaws
◯: Hardly any visible flaws
Δ: Slightly visible flaws
X: Flaws essentially not concealed
(*2) Painting Workability
Painting workability attributable to each surface treatment agent was evaluated based on the criteria indicated below.
◯: Able to easily apply a uniform finish
Δ: Unable to easily apply a uniform finish and required considerable time
X: Required considerable time and unevenness remained
(*3) Dirt Removability
Each of the test samples coated with the surface treatment agents was exposed outdoors for 3 months followed by evaluating the ease by which dirt was able to be removed from each of the test samples following exposure based on the criteria indicated below.
⊙: Dirt able to be completely removed by rinsing the test sample with water only following exposure
◯: Dirt able to be completely wiped off with a cloth after rinsing the test sample with water following exposure
Δ: Slight amount of dirt remained even if wiped with a cloth after rinsing the test sample with water following exposure
X: Considerable dirt remained even if wiped with a cloth after rinsing the test sample with water following exposure
(*4) Water Contact Angle
Water droplets comprised of 10 mg of deionized water were dropped onto each test sample in an atmosphere at 23° C. and 65% RH followed by measurement of contact angle within 1 minute after dropping using the Model CA-X Contact Angle Meter available from Kyowa Interface Science Co., Ltd.
⊙: Contact angle of 100° or more
◯: Contact angle of 90° or more
Δ: Contact angle of 80° or more
X: Contact angle of less than 80°
(*5) Water Sliding Angle
Deionized water (30 μL) was dropped onto the surface of each of the test samples, and after allowing to stand for 15 minutes at 25° C., each test piece was slowly tilted, and the angle at which the water droplet began to slide down the test sample (sliding angle) was measured using the Model CA-X Contact Angle Meter available from Kyowa Interface Science Co., Ltd.
⊙: Sliding angle of 20° or less
◯: Sliding angle of more than 20° to 30°
Δ: Sliding angle of more than 30° to 50°
X: Sliding angle of more than 50°

Each of the test samples coated with the surface treatment agents was visually observed outdoors under sunlight, and whether or not the flaws prior to application of the surface treatment agent were concealed was evaluated based on the criteria indicated below.
[symbol] : No visible flaws
◯: Hardly any visible flaws
Δ: Slightly visible flaws
x: Flaws essentially not concealed
*2: Painting Workability

Painting workability attributable to each surface treatment agent was evaluated based on the criteria indicated below.
◯Able to easily apply a uniform finish
Δ: Unable to easily apply a uniform finish and required considerable time
x: Required considerable time and unevenness remained
*3: Dirt Removability

Each of the test samples coated with the surface treatment agents was exposed outdoors for 3 months followed by evaluating the ease by which dirt was able to be removed from each of the test samples following exposure based on the criteria indicated below.
[symbol] : Dirt able to be completely removed by rinsing the test sample with water only following exposure
◯: Dirt able to be completely wiped off with a cloth after rinsing the test sample with water following exposure
Δ: Slight amount of dirt remained even if wiped with a cloth after rinsing the test sample with water following exposure
x: Considerable dirt remained even if wiped with a cloth after rinsing the test sample with water following exposure
*4: Water Contact Angle

Water droplets comprised of 10 mg of deionized water were dropped onto each test sample in an atmosphere at 23° C. and 65% RH followed by measurement of contact angle within 1 minute after dropping using the Model CA-X Contact Angle Meter available from

Kyowa Interface Science Co., Ltd.

[symbol] : Contact angle of 100° or more
◯: Contact angle of 90° or more
Δ: Contact angle of 80° or more
x: Contact angle of less than 80°
*5: Water Sliding Angle

Deionized water (30 μL) was dropped onto the surface of each of the test samples, and after allowing to stand for 15 minutes at 25° C., each test piece was slowly tilted, and the angle at which the water droplet began to slide down the test sample (sliding angle) was measured using the Model CA-X Contact Angle Meter available from Kyowa Interface Science Co., Ltd.
[symbol] : Sliding angle of 20° or less
◯: Sliding angle of more than 20° to 30°
Δ: Sliding angle of more than 30° to 50°
x: Sliding angle of more than 50°

1. A surface treatment agent comprising:
(A) an acrylic resin having a hydrolysable silyl group, a hydroxyl group and a polysiloxane chain;
(B) an organopolysiloxane having a hydrolysable silyl group; and
(C) an organopolysiloxane not having a hydrolysable silyl group.

2. The surface treatment agent according to claim 1, wherein the acrylic resin (A) is obtained by copolymerizing a siloxane macromonomer (a1), a polymerizable unsaturated monomer containing a hydrolysable silyl group (a2), a polymerizable unsaturated monomer containing a hydroxyl group (a3), and as necessary, another polymerizable unsaturated monomer capable of copolymerizing therewith (a4).

3. The surface treatment agent according to claim 2, wherein the siloxane macromonomer (a1) has a number average molecular weight within the range of 300 to 30,000.

4. The surface treatment agent according to claim 2, wherein the acrylic resin (A) is obtained by copolymerizing 1 to 40% by weight of the siloxane macromonomer (a1), 5 to 50% by weight of the polymerizable unsaturated monomer containing a hydrolysable silyl group (a2), 1 to 40% by weight of the polymerizable unsaturated monomer containing a hydroxyl group (a3), and 0 to 93% by weight of the other polymerizable unsaturated monomer (a4) based on the total weight of monomers (a1) to (a4).

5. The surface treatment agent according to claim 1, wherein the acrylic resin (A) has a number average molecular weight within the range of 1,000 to 100,000.

6. The surface treatment agent according to claim 1, wherein the organopolysiloxane having a hydrolysable silyl group (B) has an Si—C bond.

7. The surface treatment agent according to claim 1, wherein the organopolysiloxane having a hydrolysable silyl group (B) has a methyl group that bonds to a silicon atom.

8. The surface treatment agent according to claim 1, wherein the organopolysiloxane having a hydrolysable silyl group (B) contains an organopolysiloxane (b2) having both a three-dimensional organopolysiloxane backbone and a linear organopolysiloxane backbone in a molecule thereof.

9. The surface treatment agent according to claim 1, wherein the organopolysiloxane not having a hydrolysable silyl group (C) contains a polyether-modified silicone oil having a polyoxyalkylene group.

10. The surface treatment agent according to claim 1, wherein the organopolysiloxane not having a hydrolysable silyl group (C) has a viscosity of 10,000 cSt (25° C.) or less.

11. The surface treatment agent according to claim 1, comprising 10 to 70% by weight of the acrylic resin having a hydrolysable silyl group, a hydroxyl group and a polysiloxane chain (A), 25 to 85% by weight of the organopolysiloxane having a hydrolysable silyl group (B), and 5 to 65% by weight of the organopolysiloxane not having a hydrolysable silyl group (C) based on the total weight of components (A), (B) and (C).

12. The surface treatment agent according to claim 1, further comprising a polyisocyanate compound (D).

13. The surface treatment agent according to claim 12, wherein the polyisocyanate compound (D) is an isocyanurate form of hexamethylene diisocyanate.

14. The surface treatment agent according to claim 1, further comprising a curing catalyst.

15. The surface treatment agent according to claim 1, further comprising a particle flow adjuster.

16. The surface treatment agent according to claim 1, forming a coated film having a water contact angle of 85° or more and a water sliding angle of 40° or less.

17. A surface treatment method comprising: applying the surface treatment agent according to claim 1 to a surface to be painted.

18. The method according to claim 17, wherein the surface to be painted is a painted surface of a base material to which a paint has been applied.

19. An article which is surface-treated by the method according to claim 18.
